(19) United States
(12) Patent Application Publication
(10) Pub. No.: US 2024/0411274 A1
(43) Pub. Date: Dec. 12, 2024

(54) WATCH

(71) Applicant: REALIZATION DESAL AG, Oberwil bei Zug (CH)

(72) Inventor: Michael BONKE, Oberwil bei Zug (CH)

(21) Appl. No.: 18/701,186

(22) PCT Filed: Nov. 14, 2022
(86) PCT No.: PCT/EP2022/081777

§ 371 Date: Apr. 12, 2024

(30) Foreign Application Priority Data
Nov. 16, 2021 (DE) 10 2021 129 877.6

(51) Int. Cl. G04G 3/02; G04F 5/06

(52) U.S. Cl. CPC G04G 3/025; G04F 5/063

(57) ABSTRACT

The invention relates to a watch, in particular a wristwatch, comprising an electro-optical converter, an opto-electrical converter, a light wave guide, a useful signal generating device and a watch display device. The electro-optical converter is formed to generate and feed a clocked light signal into the light wave guide. A reflector is arranged at a reflector end of the light wave guide, through which the clocked light signal is reflectable back into the light wave guide. A decoupling device is arranged at a feeding end of the light wave guide and is formed to decouple the reflected clocked light signal into the opto-electrical converter. The opto-electrical converter is formed to generate an electrical signal based on the reflected clocked light signal. The watch comprises an electrical signal path between the opto-electrical converter and the electro-optical converter, wherein the electro-optical converter is controllable for generating the clocked light signal based on the electrical signal of the opto-electrical converter. The useful signal generating device is formed to generate a useful signal based on a frequency of the electrical signal, wherein the watch display device is formed to display the time based on the useful signal.

### CROSS-REFERENCE TO RELATED APPLICATIONS

This application is a National Stage of International Application No. PCT/EP2022/081777, filed Nov. 14, 2022, which claims priority based on German Patent Application Nos. 102021129877.6, filed Nov. 16, 2021, the entire disclosures of which are incorporated herein by reference.

### TECHNICAL FIELD

The invention relates to a watch, in particular a wristwatch.

### BACKGROUND

Quartz watches and mechanical watches with self-winding or manual winding are known from the state of the art. Quartz watches are clocked by the frequency of an oscillation quartz crystal. On the other hand, self-winding mechanical watches, also known as automatic watches, and hand-winding mechanical watches are generally controlled by the oscillation of a balance wheel, which controls the so-called escapement.

### SUMMARY

The object of the invention is to provide a watch that is as precise and compact as possible.

A watch, in particular a wristwatch, is described below, comprising at least the following: an electro-optical converter, an opto-electrical converter, a light wave guide, a useful signal generating device and a watch display device.

The electro-optical converter is formed to generate a clocked light signal and to feed the clocked light signal into the light wave guide. The feeding of the clocked light signal generated by the electro-optical converter into the light wave guide takes preferably place indirectly. “Indirectly” means in particular that at least one further component is arranged between the electro-optical converter and the light wave guide.

A reflector is arranged at a reflector end of the light wave guide, through which the clocked light signal is reflectable back into the light wave guide.

A decoupling device is arranged at a feeding end of the light wave guide, which is formed to decouple the reflected clocked light signal into the opto-electrical converter. In particular, the feeding of the clocked light signal into the light wave guide occurs via the decoupling device. In direction from the electro-optical converter to the light wave guide, in particular to the feeding end of the light wave guide, the decoupling device is formed such to let the light signal pass through, wherein in direction from the light wave guide, in particular from the reflector end of the light wave guide, to the electro-optical converter, the decoupling device is set up to decouple the reflected light signal.

Within the scope of the invention, the feeding end of the light wave guide can also be characterized as a first end and the reflector end as a second end. It is to be understood that the feeding end and the reflector end are different, in particular opposite, ends of the light wave guide.

The opto-electrical converter is formed to generate an electrical signal based on the reflected clocked light signal.

The watch further comprises an electrical signal path between the opto-electrical converter and the electro-optical converter. This means in particular that the electrical signal generated by the opto-electrical converter passes through the electrical signal path in direction from the opto-electrical converter to the electro-optical converter. In this case, the electro-optical converter is controllable for generating the clocked light signal based on the electrical signal of the opto-electrical converter.

The useful signal generating device is formed to generate a useful signal based on a frequency of the electrical signal.

The watch display device is formed to display the time based on the useful signal.

The watch according to the present invention has the advantage that the light wave guide is the frequency-determining element. In other words, the frequency used as a reference for the clocking of the watch is based on the duration of the travel of the light through the light wave guide. In particular by arranging the reflector at the reflector end of the light wave guide, a distance that the light has to cover in the light wave guide can be doubled for the same length of the light wave guide. This leads to a higher accuracy of the clocking of the watch. Alternatively, the length of the light wave guide can be halved for the same light path of the light signal, what saves space in the watch and halves the investment in the light wave guide, i.e., requires less effort. Thus, a desired reference frequency for the clocking of the watch can be achieved with a more compact design of the watch. In this case, in particular the costs for the light wave guide and thus also for the watch can be reduced. This is particularly advantageous, when the light wave guide is formed as a hollow-core fiber with regard to the aspect of precision of the watch, because a hollow-core fiber is very expensive to manufacture or acquire. For example, a hollow-core fiber with a length of 20 m would account for more than 95% of the total costs of the watch. By providing the reflector at the reflector end of the light wave guide. the cost price of the watch can thus be reduced by almost 50%.

Another advantage of the proposed light-controlled watch is that the clock generation is independent of influences such as for example a movement or a position (horizontal or vertical) of the watch. Thus, in particular, a light-controlled wristwatch according to the present invention is significantly more precise than a wristwatch with a mechanical oscillation device, which is slowed down or accelerated by any movement of the wrist of the wearer of the watch, in which the degree of tension of the drive spring of the clockwork has an influence on the escapement and, via this, also on the frequency of the tandem of balance wheel/escapement and the position of which influences the oscillation behavior of the balance wheel. Further, problems that arise in a watch with a frequency-determining oscillation crystal, such as for example the so-called ageing of the oscillation crystal, i.e., a deviation in oscillation frequency, that occurs over time due to the penetration of foreign atoms into the oscillation crystal or due to other time-related circumstances, do not arise in the proposed light-controlled watch. In addition, a clock generation using a piezoelectric oscillation crystal, as well as a clock generation using a balance wheel, is also based on a mechanical oscillation, namely the piezoelectrically excited mechanical oscillation of the oscillation crystal. Such a mechanical oscillation is more susceptible to a damping than the clocked light signal in the proposed watch. Thus. the light-controlled watch of the present invention is more accurate than a watch, in which the clock is generated by the oscillation of a piezoelectric oscillation crystal.

In addition, the light-controlled watch according to the present invention provides great flexibility in terms of selecting the clock frequency of the watch, which, as already described, is based on the light travel time in the light wave guide,. The clock frequency can easily be selected according to the respective requirements of the watch and/or design preferences of the owner or, in the case of a wristwatch, the wearer of the watch. Thus, it is for example possible to form the light wave guide in a simple manner such that the clock frequency has a certain value.

It is to be understood that, for feeding the clocked light signal into the light wave guide, the electro-optical converter is set up to convert an electrical input signal into the light signal.

It is further to be understood that, preferably, the electrical signal is also clocked, because the light signal is clocked.

In an advantageous manner, the electro-optical converter, the light wave guide, the reflector, the opto-electrical converter, the decoupling device and the electrical signal path form an oscillation system within the scope of the invention. The oscillation system, in turn, forms within the scope of the invention together with the useful signal generating device a clock generator arrangement in an advantageous manner.

The clocked light signal can preferably be an analog clocked light signal, in particular a sinusoidal light signal. However, the analog light signal can also have another shape than the sinusoidal shape. Correspondingly, the electrical signal generated by the opto-electrical converter can preferably be an analog electrical signal, in particular a sinusoidal electrical signal. Correspondingly to the light signal, however, the analog electrical signal can, however, have another shape than the sinusoidal shape.

Preferably, the opto-electrical converter comprises a photodiode. The photodiode is set up to convert the clocked light signal into the electrical signal.

According to an alternative advantageous design of the watch, the clocked light signal can be a digital (pulse-like) light signal. Correspondingly, the electrical signal generated by the opto-electrical converter can in particular be a digital electrical signal.

Preferably, the reflector is formed as a concave mirror. The concave mirror is in this case advantageously set up to bundle diverging light exiting from the light wave guide. In particular, the concave mirror can be a spherical concave mirror. However, it is also possible that the reflector is another type of mirror, which is suitable in particular for back-reflecting the light signal arriving at the reflector end. According to an alternative advantageous design of the invention, the reflector can be formed as a plane mirror, which is arranged directly at the reflector end, i.e., directly at the corresponding output, of the light wave guide. For this purpose, an end cap can in an advantageous manner be arranged directly at the reflector end of the light wave guide, the inner surface of which, i.e., the surface of the end cap facing the reflector end of the light wave guide, is reflectorized. In other words, the plane mirror can be formed by a mirrored end cap. This makes it possible that little or no light is lost after reflection. The design of the invention with the mirrored end cap has the further advantage that, when for example a separate end cap is provided at the reflector end in addition to a concave mirror, a separate component and the adjustment associated with it can be saved.

Preferably, the decoupling device comprises a fiber splitter or a partially transparent mirror. The partially transparent mirror can in particular be formed as a partially transparent plane mirror or as a partially transparent concave mirror.

Preferably, the electro-optical converter can comprise a light-emitting diode, in particular a pigtail light-emitting diode. Alternatively, the electro-optical converter can preferably comprise a semiconductor laser, in particular a pigtail semiconductor laser.

Preferably, a lens can be arranged between the decoupling device and the electro-optical converter. In this configuration of the watch, the feeding of the clocked light signal generated by the electro-optical converter into the light wave guide takes place indirectly via the lens and the decoupling device.

The lens can in an advantageous manner be formed to refract light emitted by the electro-optical converter in such a way that the light propagates in a parallel direction. For this purpose, a converging lens can be used in an advantageous manner. In this case, a focal point of the converging lens is in an advantageous manner located on the point, from which the light generated by the electro-optical converter is emitted. However, the lens can also be designed to collect diverging light emitted by the electro-optical converter and focus it on a point, in particular on the center of the light wave guide. In other words, the lens can be formed to bundle diverging light from the electro-optical converter.

Within the scope of the present invention, the lens can in an advantageous manner comprise a single lens element or an optical system with at least two lens elements.

Preferably, a feeding lens is arranged between the light wave guide and the decoupling device. Particularly preferably, the feeding lens is arranged directly at the feeding end of the light wave guide. “Directly” here means that no further component is provided between the light wave guide and the feeding lens. The feeding lens is formed in advantageous manner to bundle light entering the light wave guide. This means that light can be fed into the light wave guide in a bundled manner.

Preferably. the electrical signal path comprises an amplifier (electrical amplifier) for amplifying the electrical signal. That is, the amplifier is set up to amplify the electrical signal between the opto-electrical converter and the electro-optical converter.

The electrical amplifier can preferably further be set up to convert the electrical signal. That is, a voltage signal applied at the input of the electrical amplifier is converted into a current signal exiting at the output of the electrical amplifier, or a current signal entering the input of the electrical amplifier is converted into a voltage signal applied at the output of the electrical amplifier. The respective output signal of the electrical amplifier is in this case amplified compared with the respective input signal of the electrical amplifier.

In an advantageous manner, the amplifier is arranged downstream of the opto-electrical converter in terms of signaling. This means in particular, that the input signal of the electrical amplifier corresponds to an output signal of the opto-electrical converter or is based on an output signal of the opto-electrical converter.

In particular, the electrical amplifier can be formed to convert an input current into an output voltage. Particularly preferably, the amplifier is formed as a transimpedance amplifier. The transimpedance amplifier can in this case advantageously convert an input current into a proportional output voltage. In such a design of the electrical amplifier, the opto-electrical converter is advantageously formed to convert the received light signal into a current signal.

Preferably, the electrical signal path comprises a pulse generator for generating an electrical pulse based on the electrical signal for driving the electro-optical converter. This means that the electro-optical converter is controllable by the electrical pulse. Particularly preferably, the pulse generator can comprise a monoflop. However, it is also possible that the pulse generator is formed differently.

Preferably, the electrical signal path is set up to invert the electrical signal and to alternately switch the electro-optical converter on and off using the inverted electrical signal.

For this purpose, the electrical signal path can comprise an inverter (inverter circuit) according to an advantageous option. The inverter is in this case advantageously formed to alternately switch the electro-optical converter on and off. The inverter can in this case be a separate electronic component or part of the electro-optical converter. According to an alternative advantageous option, an output of the electrical amplifier described above can be an inverting output. By the inverting output, the inversion of the electrical signal takes place. In the case of an inverting output of the electrical amplifier, no separate inverter is advantageously provided in the electrical signal path. According to a further alternative advantageous option, the inverting of the electrical signal can be realized using software of an integrated circuit.

Within the context of the present invention, the useful signal generating device can also be characterized as an electronic useful signal generating device.

For generating the above-mentioned useful signal, the useful signal generating device can preferably comprise a pulse counter (binary counter). In this case, the pulse counter is in an advantageous manner set up to count the control signal. The useful signal generating device is advantageously set up to generate the useful signal, when a count value of the control signal is equal to a predetermined count value. The predetermined count value is advantageously set to a frequency based on a light travel time in the light wave guide of the first signal path.

Alternatively, the useful signal generating device for generating the above-mentioned useful signal can advantageously comprise a frequency divider. The frequency divider is set up to divide the frequency of the control signal. Here, the useful signal advantageously corresponds to the output signal of the frequency divider. In particular, the frequency of the control signal can in this case correspond to a multiple of two, in particular a power of two, such as for example 524288 Hz or 1048576 Hz. The frequency of the control signal can be in this case advantageously broken down to 1 Hz or another frequency, such as 8 Hz, using the frequency divider. The broken down frequency corresponds to the useful signal, based on which the watch display device is set up to display the time. It should be noted that with a useful signal with a frequency of, for example, 8 Hz, the jump of a second hand of a mechanical watch display device, which then occurs 8 times per second, is no longer perceived as a “jump” by the viewer.

For generating the useful signal, a combination of a frequency divider with a pulse counter is also possible. In this case, the frequency divider is advantageously arranged before the pulse counter in terms of signaling. Advantageously, the frequency of the control signal can be halved, in particular halved several times, by the frequency divider in a first step to reach an intermediate frequency. In a second step, the intermediate frequency can be brought to a desired frequency or a useful frequency using the pulse counter. Here, the useful signal generating device is advantageously set up to generate the useful signal when a count value of an output signal of the frequency divider is equal to a predetermined count value. Here, the predetermined count value is advantageously set based on the intermediate frequency achieved by the frequency divider. The procedure of halving, in particular multiple halving, of the frequency of the oscillation crystal in a first step to reach an intermediate frequency and counting down the intermediate frequency to a desired frequency in a second step is particularly advantageous in a watch, in which the control signal has a high frequency, such as for example 8.88 MHz or 10 MHz. Thus, current can be saved compared with simply counting down the frequency of the control signal.

In the case, where the control signal is analog, the useful signal generating device advantageously comprises a device for converting the analog control signal into a digital signal.

According to an advantageous design of the invention, the watch display device is a mechanical watch display device. The watch preferably comprises in this case a drive device, by which the mechanical watch display device is movable. Here, the drive device is advantageously controllable by using the useful signal. In particular, the watch display device can comprise an hour hand and/or a minute hand and/or a second hand.

Preferably, the watch can further comprise a gear train. In this case, the drive device is set up to drive the gear train. The watch display device is connected to the gear train and is movable by the gear train. The gear train preferably comprises at least one hour wheel and/or one minute wheel and/or one second wheel and/or one third wheel (intermediate wheel).

The drive device is preferably formed as a stepper motor.

According to an alternative advantageous design of the watch, the watch display device is an electronic watch display device formed to display the time based on the useful signal.

Further, the watch preferably comprises a power supply device, which is set up to supply power to the electro-optical converter and/or the useful signal generating device and/or the drive device and/or—in the case of a watch with an electronic watch display device-to the electronic watch display device.

The power supply device can preferably comprise at least one rechargeable battery. The at least one battery can preferably be charged by an energy harvesting device. The energy harvesting device can preferably comprise at least one thermogenerator and/or at least one solar cell. In particular, the thermogenerator can comprise one or multiple thermocouples.

It should be noted that, in addition to the previously described electro-optical converter, the watch can preferably have a further electro-optical converter. It is also possible that the watch can advantageously have a further opto-electrical converter in addition to the previously described opto-electrical converter. Similarly, the watch can advantageously further have a further light wave guide, into which a light signal can be fed by the previously described electro-optical converter or the one further electro-optical converter. In this case, the previously described light wave guide is to be understood as a first light wave guide and the previously described electro-optical converter as a first electro-optical converter. Correspondingly, the further light wave guide is to be understood as a second light wave guide and the further electro-optical converter is to be understood as a second electro-optical converter.

### BRIEF DESCRIPTION OF THE DRAWINGS

Further details, advantages and features of the present invention result from the following description of embodiments with reference to the drawing, wherein identical and functionally identical components are respectively designated with the same reference sign.

FIG. 1 shows a simplified schematic view of a watch according to a first embodiment of the present invention.

FIG. 2 shows a simplified schematic view of a region of the watch according to the first embodiment,

FIG. 3 shows a simplified schematic view of a region of the watch according to the first embodiment,

FIG. 4 shows a simplified schematic view of a region of a watch according to a second embodiment,

FIG. 5 shows a simplified schematic view of a region of a watch according to a third embodiment, and

FIG. 6 shows a simplified schematic view of a region of a watch according to a fourth embodiment.

### DETAILED DESCRIPTION

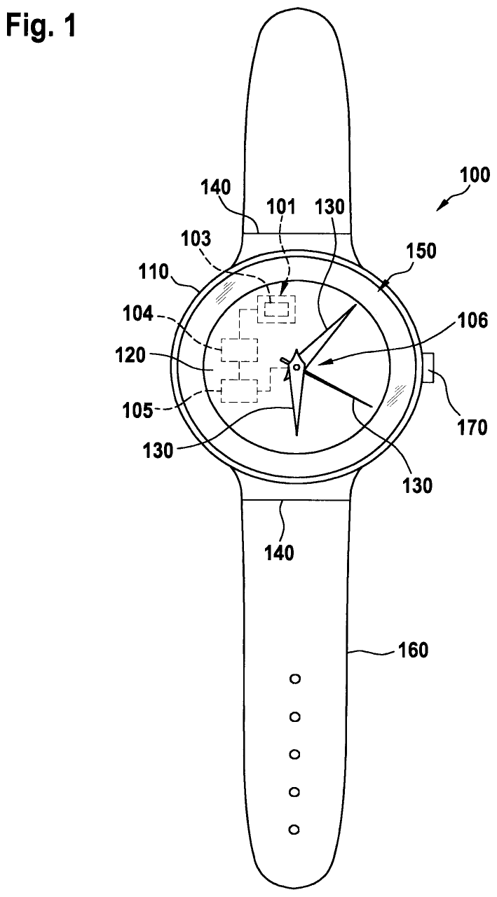

Hereinafter, with reference to FIGS. 1 to 3, a watch 100 according to a first embodiment of the present invention will be described in detail.

As is apparent from FIG. 1, the watch 100 is formed as a wristwatch and thus comprises two connectors 140 for a wristwatch 160. However, it is also possible that the watch 100 is a wall clock, a grandfather clock, a table clock or a watch of another type.

The watch 100 comprises a watch case 110 and a watch glass 150 arranged thereon. The watch 100 further comprises a dial 120, a setting wheel 170 and three hands 130 for indicating the hours, minutes and seconds. The hands 130 are parts of a mechanical watch display device 106 for displaying the time.

The watch 100 further comprises a clock generator arrangement 101, a gear train 105 and a drive device 104 for driving the gear train 105. The drive device 104 is in particular a stepper motor. The gear train 105 is connected to the watch display device 106, so that the hands 130 of the watch display device 106 are moved. In particular, the gear train 105 comprises at least an hour wheel, a minute wheel and a second wheel, which are respectively connected to one of the hands 130.

The clock generator arrangement 101 is set up to determine a frequency relevant to the clocking of the watch 100. Part of the clock generator arrangement 101 is a useful signal generating device 103, which is formed to generate a useful signal. Thereby, the useful signal generating device 103 can comprise a pulse counter. Based on the useful signal, the drive device 104 is controlled to move the gear train 105.

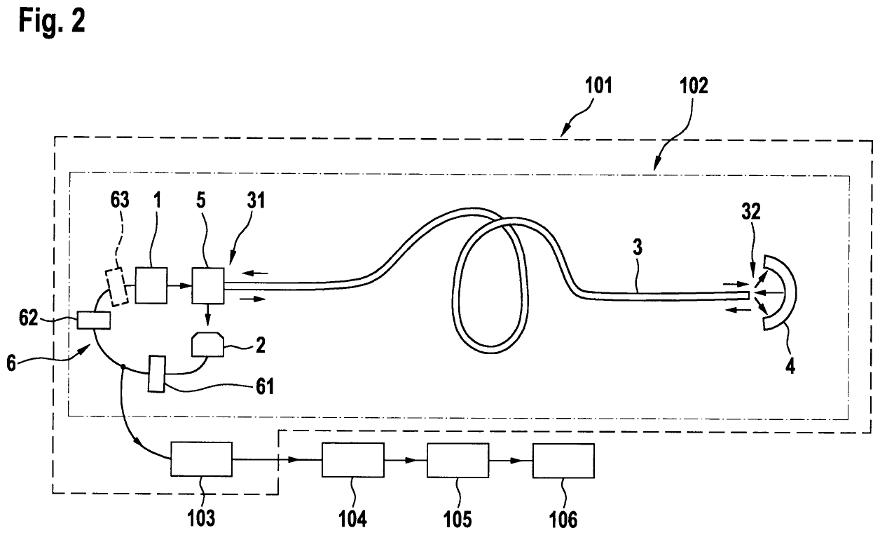

One recognizes from FIG. 2 that the watch 100 comprises an electro-optical converter 1, an opto-electrical converter 2, a light wave guide 3, a reflector 4 and a decoupling device 5. An electrical signal path 6 is provided between the opto-electrical converter 2 and the electro-optical converter 1, which connects the opto-electrical converter 2 and the electro-optical converter 1 to each other in terms of signaling. The electro-optical converter 1, the opto-electrical converter 2, the light wave guide 3, the reflector 4, the decoupling device 5 and the electrical signal path 6 form an oscillation system 102. The oscillation system 102 together with the useful signal generating device 103 forms the clock generator arrangement 101.

The electro-optical converter 1 is formed to generate a clocked light signal. Further, the electro-optical converter 1 is formed for feeding the clocked light signal into the light wave guide 3. In particular, the light signal is digital (pulse-like).

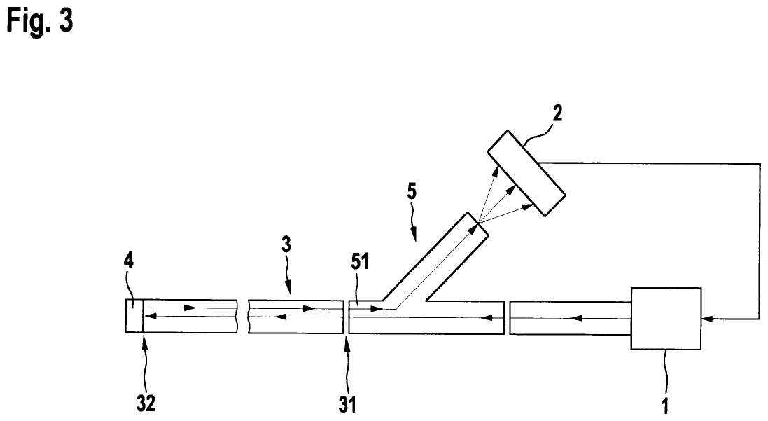

Here, the electro-optical converter 1 comprises a semiconductor laser, in particular a pigtail semiconductor laser, or a light-emitting diode, in particular a pigtail light-emitting diode, as results from FIG. 3.

The reflector 4 is arranged at a reflector end 32 of the light wave guide 3. Through the reflector 4, light that is fed into the light wave guide 3 at a feeding end 31 and exits the light wave guide 3 at the reflector end 32 is reflectable back into the light wave guide 3.

For this purpose, as can be learnt from FIG. 2, a concave mirror can be used in particular as the reflector 4. The concave mirror is in this case set up to bundle again diverging light exiting from the light wave guide 3. However, it is also possible that the reflector 4 is a different type of mirror, which is suitable in particular for back-reflection of the light signal arriving at the reflector end 32. FIG. 3 shows the reflector 4 only schematically.

The decoupling device 5 is arranged at the feeding end 31 of the light wave guide 3 and is formed to decouple the reflected clocked light signal into the opto-electrical converter 2. In particular, the decoupling device 5 is positioned between the light wave guide 3 and the electro-optical converter 1. The decoupling device 5 is formed here as a fiber splitter 51. The feeding of the clocked light signal into the light wave guide 1 occurs via the decoupling device 5, which is set up to let light through in direction from the electro-optical converter 1 to the light wave guide 3.

The opto-electrical converter 2, which comprises a photodiode, is formed to generate an electrical signal based on the reflected clocked light signal. The electrical signal is in this case also digital (pulse-like). Based on the electrical signal of the opto-electrical converter 2, the electro-optical converter 1 can be controlled to generate the clocked light signal. The useful signal generating device 103 is in this case set up to generate the useful signal based on the electrical signal.

It can also be learnt from FIG. 1 that the electrical signal path 6 comprises an amplifier 61 for amplifying the electrical signal and a pulse generator 62 for generating an electrical pulse based on the electrical signal, in particular the amplified electrical signal. The electro-optical converter 1 can be controlled by using the electrical pulse. For this purpose, the pulse generator 62 can comprise a monoflop.

During operation of the watch 100, the electro-optical converter 1 feeds the clocked light signal into the light wave guide 3 via the decoupling device 5, in this embodiment the fiber splitter 51. The light signal is reflected back into the light wave guide 3 by the reflector 4 at the reflector end 32 and decoupled into the opto-electrical converter 2 using the decoupling device 5.

The opto-electrical converter 2 converts the light signal into the electrical signal, which is then amplified via the amplifier 61 and serves as the input signal of the pulse generator 62.

In a first modification of the first embodiment, it is also possible that the electrical signal path 6 is set up to invert the electrical signal and alternately switch the electro-optical converter 1 on and off using the inverted electrical signal.

For this purpose, the electrical signal path 6 can comprise an inverter 63. The inverter 63, which is formed as a separate electronic component, is in an advantageous manner arranged between the pulse generator 62 and the electro-optical converter 1. Alternatively, the inverter 63 can be part of the electro-optical converter 1. According to a further alternative, an output of the amplifier 61 can be an inverting output, through which the inversion of the electrical signal takes place. According to a still further alternative, the inverting of the electrical signal can be realized using a software of an integrated circuit.

According to a second modification, it is also possible that the electrical signal path 6 does not comprise a pulse generator. In contrast to the first embodiment or its modification, the clocked light signal is in this case not a digital (pulse-like) signal, but a continuous signal. The continuous light signal reaches the reflector end 32 of the light wave guide 3 after a certain time and is reflected back into the light wave guide 3 by the reflector 4.

The light signal then makes its way back to the feeding end 31 of the light wave guide 3, where it encounters both the electro-optical converter 1 and the opto-electrical converter 2. The opto-electrical converter 2 reports the arrival of the light signal to the electro-optical converter 1 via the electrical signal path 6, but unlike in the first embodiment or its first modification, the electro-optical converter 1 does not feed a new light signal into the light wave guide 3, because here the light signal is continuous and is still being fed by the opto-electrical converter 2 at the time of reporting. By inverting the electrical signal, in particular by the inverter 63, the electro-optical converter 1 is now switched off. As soon as the end of the light signal has run forth and back through the light wave guide 3 and arrives at the opto-electrical converter 2, the opto-electrical converter 2 detects the drop in light and signals this again to the opto-electrical converter 1. Thereby, this is switched on again due to the again inverted electrical signal. This “on-off-on” process is repeated in the predetermined duration required for the light signal to travel back and forth through the light wave guide 3.

The watch 100 according to the first embodiment and/or the described modifications has the advantage that here the light path, i.e., the distance that the clocked light signal covers in the light wave guide 3, is twice as long as the light wave guide 3. Thus, the light path of the light signal can be doubled for the same length of the light wave guide 3, what enables a higher accuracy of the clocking of the watch 100. Alternatively, the length of the light wave guide 3 can be halved for the same light path of the light signal, what saves space in the watch 100 and halves the investment in the first light wave guide 3, i.e., requires less effort.

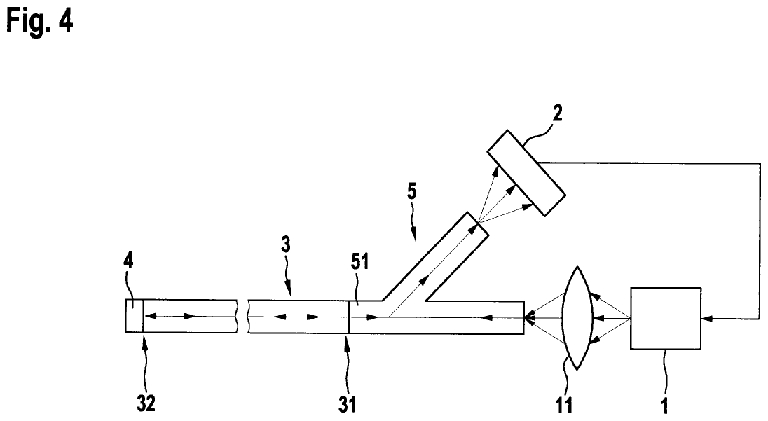

FIG. 4 refers to a watch 100 according to a second embodiment of the invention.

The watch 100 according to the second embodiment differs from that according to the first embodiment or the modifications thereof in that a lens 11 is arranged between the decoupling device 5 and the electro-optical converter 1. Further, the electro-optical converter 1 comprises a semiconductor laser, which is not formed as a pigtail semiconductor laser. Alternatively, the electro-optical converter 1 can comprise a light-emitting diode that is not formed as a pigtail light-emitting diode.

As results from FIG. 4, the lens 11 is formed in particular as a convex lens and serves to refract the light emitted by the electro-optical converter 1 in different directions, such that the light beams are bundled after the lens 11. In other words, the lens 11 is formed to bundle diverging light of the electro-optical converter 1.

Here, the feeding of the clocked light signal into the light wave guide 3 takes place by the lens 11 and the decoupling device 5.

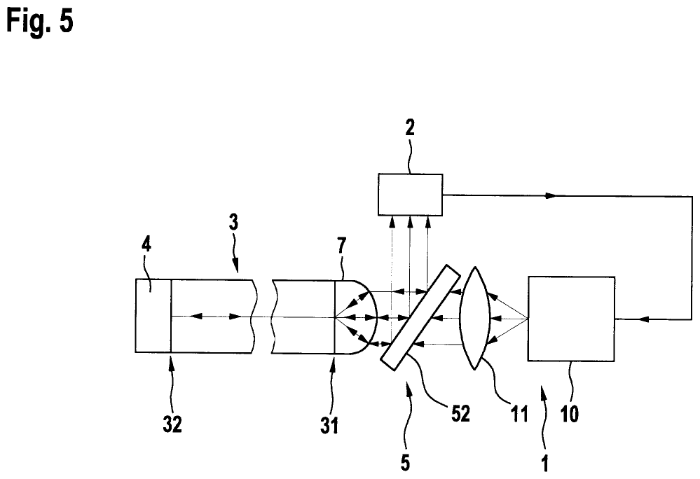

FIG. 5 refers to a watch 100 according to a third embodiment of the invention.

The watch 100 according to the third embodiment differs from that according to the second embodiment in that the decoupling device 5 comprises a partially transparent mirror 52 in the form of a partially transparent plane mirror instead of the fiber splitter 51, and in that a feeding lens 7 is arranged between the decoupling device 5 and the light wave guide 3. In particular, the feeding lens 7 is mounted directly at the feeding end 31 of the light wave guide 3. The feeding lens 7 is formed to bundle light entering the light wave guide 3.

Further, the lens 11 is formed to refract light emitted by the electro-optical converter 1, in such a way that the light propagates in a parallel direction.

Like also the fiber splitter 51 in the watch 100 according to the first embodiment. the partially transparent mirror 52 serves to decouple the reflected clocked light signal into the opto-electrical converter 2.

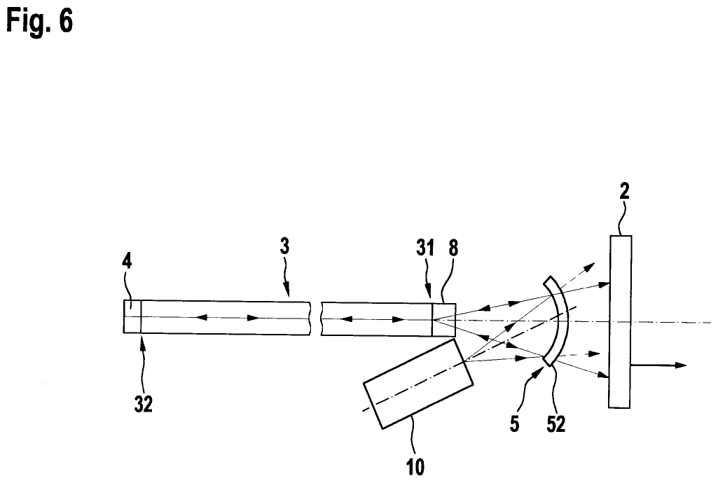

FIG. 6 refers to a watch 100 according to a fourth embodiment of the invention.

The watch 100 according to the fourth embodiment differs from that according to the third embodiment in that the decoupling device 5 comprises a partially transparent mirror 52 in the form of a partially transparent concave mirror. The partially transparent concave mirror can also be characterized as a semi-transparent focusing mirror. As results from FIG. 6, a concave surface of the partially transparent concave mirror faces the electro-optical converter 1.

The partially transparent concave mirror is set up and/or arranged relative to the light wave guide 3 in such a way that the clocked light signal generated by the electro-optical converter 1 is first reflected by the partially transparent concave mirror into the light wave guide 3 and passes after its reflection at the reflector 4 through the partially transparent concave mirror so that the clocked light signal reflected by the reflector 4 is decoupled into the opto-electrical converter 2.

Further, in the watch 100 according to the fourth embodiment, the reflector 4 is arranged directly at the reflector end 32 of the light wave guide 3 and is advantageously formed as a plane mirror. To this end, an end cap can in an advantageous manner be arranged directly at the reflector end 32 of the light wave guide 3, the inner surface of which, i.e., the surface of the end cap facing the reflector end 32 of the light wave guide 3, is reflectorized. This makes it possible that no or little light is lost after the reflection.

Furthermore, the watch 100 according to the fourth embodiment comprises a feeding window 8, which is arranged directly at a feeding end 31 of the light wave guide 3. An end cap, which is formed in such a way as to let light in, can be used as the feeding window 8.

In addition to the above written description of the invention, for a supplementary disclosure thereof, explicit reference is hereby made to the graphic representation of the invention in FIGS. 1 to 6.

1. A watch, in particular a wristwatch, comprising
an electro-optical converter,
an opto-electrical converter,
a light wave guide,
a useful signal generating device, and
a watch display device,
wherein:
the electro-optical converter is formed to generate and feed a clocked light signal into the light wave guide,
a reflector is arranged at a reflector end of the light wave guide, through which the clocked light signal is reflectable back into the light wave guide,
a decoupling device is arranged at a feeding end of the light wave guide, which is formed to decouple the reflected clocked light signal into the opto-electrical converter,
the opto-electrical converter is formed to generate an electrical signal based on the reflected clocked light signal,
the watch comprises an electrical signal path between the opto-electrical converter and the electro-optical converter, wherein the electro-optical converter is controllable for generating the clocked light signal based on the electrical signal of the opto-electrical converter,
the useful signal generating device is adapted to generate a useful signal based on a frequency of the electrical signal, and
the watch display device is adapted to display the time based on the useful signal.

2. The watch of claim 1, wherein the reflector is formed as a concave mirror or as a plane mirror, which is arranged directly at the reflector end of the light wave guide.

3. The watch of claim 1, wherein the decoupling device comprises a fiber splitter or a partially transparent mirror, in particular a partially transparent plane mirror or a partially transparent concave mirror.

4. The watch of claim 1, wherein the electro-optical converter comprises a light-emitting diode or a semiconductor laser.

5. The watch claim 4, wherein the light-emitting diode is a pigtail light-emitting diode or wherein the semiconductor laser is a pigtail semiconductor laser.

6. The watch of claim 1, wherein a lens is arranged between the decoupling device and the electro-optical converter.

7. The watch of claim 1, wherein a feeding lens or a feeding window is arranged between the light wave guide and the decoupling device, in particular directly at the feeding end of the light wave guide.

8. The watch of claim 1, wherein the electrical signal path comprises an amplifier for amplifying the electrical signal.

9. The watch of claim 1, wherein the electrical signal path comprises a pulse generator for generating an electrical pulse based on the electrical signal for driving the electro-optical converter.

10. The watch of claim 1, wherein the electrical signal path is set up to invert the electrical signal and alternately switch on and off the electro-optical converter via the inverted electrical signal.
